(19) United States
(12) Patent Application Publication
(10) Pub. No.: US 2024/0150008 A1
(43) Pub. Date: May 9, 2024

(54) RESILIENT AND SCALABLE MICROTEXTURED COATINGS FOR QUIET AND EFFICIENT URBAN AIR MOBILITY

(71) Applicant: Purdue Research Foundation, West Lafayette, IN (US)

(72) Inventors: Luciano Castillo, Carmel, IN (US); Victor Manuel Castano-Meneses, Queretaro (MX); Tanya Purwar, West Lafayette, IN (US); J.Arturo Silva-Ordaz, Queretaro (MX)

(21) Appl. No.: 18/497,848

(22) Filed: Oct. 30, 2023

Related U.S. Application Data
(60) Provisional application No. 63/421,169, filed on Oct. 31, 2022.

(51) Int. Cl. B64C 11/20; B63H 1/15; B63H 1/26

(52) U.S. Cl. CPC B64C 11/20; B63H 1/15; B63H 1/26

(57) ABSTRACT

A reduced noise curved surface, including the elements of a curved substrate and a plurality of micropillars operationally connected to the curved substrate and defining a coating, wherein the respective micropillars are positioned to define an aperiodic sequence based on the golden ratio, and wherein the plurality of aperiodically sequenced micropillars increase sound absorption and drag reduction of the curved surface.

### CROSS-REFERENCE TO RELATED APPLICATIONS

This patent application claims priority to U.S. provisional patent application Ser. No. 63/421,169, filed on Oct. 31, 2023, the entirety of which is incorporated herein by reference.

### TECHNICAL FIELD

The present novel technology relates generally to the field of materials science and, more particularly, to sound-dampening metamaterial coatings for rotor blades.

### BACKGROUND

With the rapid increase in planning and designing of Urban Air Mobility (UAM), one of the major concerns is noise pollution. Aviation noise from helicopters or drones, arising from blade-vortex interaction and/or due to displacement of fluid in the flow field by rotor blade and/or by accelerating force on fluid generated by moving blade surface, result in different broadbands of noise that can be very loud, disruptive, and annoying to the surrounding community. Thus, it is a challenge introducing and maintaining a network of potentially noisy urban air transportation at lower altitudes, as a part of daily life. The present novel technology addresses this need.

### BRIEF DESCRIPTION OF THE DRAWINGS

FIG. A graphically depicts a first generation Fibonacci sequence (LLS) as known in the PRIOR ART.

FIG. B graphically depicts a second generation Fibonacci sequence (LLSLLSL) as known in the PRIOR ART.

FIG. C graphically depicts a slant variant Fibonacci sequence skipping every other letter as know in the PRIOR ART.

FIG. D graphically depicts a 2D lattice applying mathematical noise reduction principles to a Fibonacci pattern as know in the PRIOR ART.

FIG. 1 is a graphic illustration of a diverging micropillar.

FIG. 2 is a first graphic illustration of an experimental configuration for determining noise level according to a first embodiment of the present invention.

FIG. 3 is a second graphic illustration of an experimental configuration for determining noise level according to a first embodiment of the present invention.

FIG. 4 graphically illustrates a configuration for measuring the Reynolds number according to a first embodiment of the present invention.

FIG. 5 illustrates in greater detail a sound chamber of FIG. 2.

FIG. 6 graphically illustrates a series of pressure measurements made alas FIG. 2.

FIG. 7 6 graphically illustrates characteristics of the pressure field microphone of FIG. 2.

FIG. 8 graphically illustrates pressure filed microphone spectra at various angles of incidence.

FIG. 9 graphically depicts a first 2D lattice applying mathematical noise reduction principles to a Fibonacci pattern according to the present novel technology.

FIG. 10 graphically depicts a second 2D lattice applying mathematical noise reduction principles to a Fibonacci pattern according to the present novel technology.

FIG. 11A graphically illustrates a dipole pressure field according to the present novel technology.

FIG. 11B graphically illustrates a quadrupole pressure field according to the present novel technology.

FIG. 12 graphically illustrates sound dampening of a curved surface according to the present novel technology.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates. At least one embodiment of the present disclosure will be described and shown, and this application may show and/or describe other embodiments of the present disclosure. It is understood that any reference to “the disclosure” is a reference to an embodiment of a family of disclosures, with no single embodiment including an apparatus, process, or composition that should be included in all embodiments, unless otherwise stated. Further, although there may be discussion with regards to “advantages” provided by some embodiments of the present disclosure, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

What will be shown and described herein, along with various embodiments of the present disclosure, is discussion of one or more tests that were performed. It is understood that such examples are by way of example only and are not to be construed as being limitations on any embodiment of the present disclosure. Further, it is understood that embodiments of the present disclosure are not necessarily limited to or described by the mathematical analysis presented herein.

Various references may be made to one or more processes, algorithms, operational methods, or logic, accompanied by a diagram showing such organized in a particular sequence. It is understood that the order of such a sequence is by example only and is not intended to be limiting on any embodiment of the disclosure.

This document may use different words to describe the same element number, or to refer to an element number in a specific family of features. It is understood that such multiple usage is not intended to provide a redefinition of any language herein. It is understood that such words demonstrate that the particular feature can be considered in various linguistical ways, such ways not necessarily being additive or exclusive.

What will be shown and described herein are one or more functional relationships among variables. Specific nomenclature for the variables may be provided, although some relationships may include variables that will be recognized by persons of ordinary skill in the art for their meaning. For example, “t” could be representative of temperature or time, as would be readily apparent by their usage. However, it is further recognized that such functional relationships can be expressed in a variety of equivalents using standard techniques of mathematical analysis (for instance, the relationship F=ma is equivalent to the relationship F/a=m). Further, in those embodiments in which functional relationships are implemented in an algorithm or computer software, it is understood that an algorithm-implemented variable can correspond to a variable shown herein, with this correspondence including a scaling factor, control system gain, noise filter, or the like.

### Underpinnings

Aerodynamic and hydrodynamic (fluid dynamic) turbulence stands as a ubiquitous and intricate phenomenon, observable in a wide array of natural and engineered systems, ranging from the graceful movement of air around urban air mobility (UAM) vehicles to the flowing waters enveloping submarines. While turbulence plays an important role in numerous applications, such as augmenting fluidic mixing and facilitating heat transfer, it simultaneously poses substantial challenges due to the concomitant generation of noise. This noise, arising from the complex interactions between turbulent flows and structures, can exert detrimental effects on the overall efficiency, performance, and environmental impact of these systems.

In the context of aerodynamics, one of the major contributors to noise is the adverse pressure gradient, which leads to flow separation and the formation of vortices around aircraft and other objects. This flow separation generates pressure drag, resulting in the creation of aerodynamic noise as the object's surface interacts with the surrounding air. Similarly, in hydrodynamics, turbulence caused by the movement of submarines' hulls and propellers also gives rise to significant noise. As the water flows around the submerged structures, vortices and fluctuations in pressure are generated, leading to the emission of hydrodynamic noise. This noise can potentially compromise the stealth capabilities of submarines, affecting their operational efficiency and posing challenges in underwater communication.

To delve deeper into the subject, we can consider the acoustic analog of the Navier-Stokes equations, known as the linearized Euler equations or the acoustic wave equation. These equations describe the behavior of small perturbations in pressure and velocity within the fluid, which are responsible for sound generation and propagation. The acoustic wave equation is given by:

Δ²p−(1/c²)(∂²p/∂t²)=0

where p is the acoustic pressure perturbation, c is the speed of sound in the fluid, ∇² represents the Laplacian operator (divergence of the gradient), and ∂²/∂² is the second derivative of pressure with respect to time. This equation describes how sound waves propagate through the fluid medium and relates the spatial variations of the acoustic pressure perturbation to its temporal variations. This relationship facilitates the understanding sound generation mechanisms within turbulent flows and the subsequent acoustic radiation in the surrounding medium.

In the realm of Urban Air Mobility (UAM), aerodynamic noise emerges as a prominent concern owing to its multifaceted origins that collectively contribute to overall noise levels. This encompasses a variety of sources, such as the rotor blades' interaction with the air, the vibrations and interactions of air-frame components, and the intricate flow patterns that arise due to the interaction between airflow and vehicle structures. Each of these elements contributes to the generation of noise, adding to the acoustic signature of UAM vehicles.

To gain deeper insights into the acoustic phenomena involved, the aeroacoustics branch of fluid dynamics comes into play. Aeroacoustics encompasses the study of sound production mechanisms within turbulent flows and the propagation of resulting acoustic waves in the surrounding medium. At the heart of aeroacoustics lie the renowned Lighthill equation and the Ffowcs Williams-Hawkings (FWH) equations, which aid in elucidating sound generation mechanisms in turbulent flows.

The Lighthill equation, derived from the linearized Euler equations, provides a fundamental expression that relates the acoustic pressure perturbation to the time rate of change of the mean square vorticity in the flow. In the context of UAM vehicles, this equation enables understanding of how the large-scale turbulent structures, generated during rotor-blade interactions or airflow around complex vehicle geometries, contribute to the acoustic emissions. Thus, the Lighthill expression offers insights into the noise generation processes that occur within UAM systems. The Lighthill equations are given by:

∂2p/∂t2=(1/p)∇·(pv′v′−T′)

where ∂2p/∂t2 is the second time derivative of the acoustic pressure perturbation p, ρ is the density of the fluid, ∇· represents the divergence operator, v′ is the fluctuating velocity vector (perturbation from mean velocity), and T′ is the fluctuating stress tensor (perturbation from mean stress tensor).

On the other hand, the FWH equations present an integral formulation of the Lighthill equation, enabling calculations of the far-field sound radiation from an unsteady flow interacting with solid body surfaces. In the case of UAM vehicles, this is particularly relevant when considering the noise generated by the interaction of airflow with various components of the vehicle, such as the air-frame and other protruding structures. By integrating the Lighthill equation over the vehicle's surface, the FWH equations allow estimation of, and analysis of, the noise radiated from different parts of the vehicle, helping to identify optimizable noise sources and potential areas for noise reduction. The Ffowcs Williams-Hawkings (FWH) equations are given by:

p(x, t)=(1/4π)∫ₛ(∂²/∂t²(1/|x−x′|)−(((1/|x−x′|)(∂²/∂t²))/|x−x′|)dS′

where p(x, t) is the acoustic pressure at a point x and time t in the far-field, x′ represents the surface integration element on the body, and S is the surface of the body.

Surface roughness has an impact on turbulence dynamics near walls and separation regions. Certain roughness patterns can cause the separation point to shift in unfavorable directions, leading to increased drag and reduced lift. Researchers have explored various techniques to delay flow separation, but some methods generate more turbulence, which in turn increases energy losses near the wall. Thus, finding a way to control flow separation without causing additional turbulence would be a preferable strategy to manage drag effectively.

Previous research efforts have been devoted to investigating a range of passive flow control methods aimed at mitigating the challenges posed by noise in turbulent flows. These techniques are designed to alter the flow dynamics and minimize turbulence levels, consequently leading to a reduction in noise generation. Among these methods are vortex generators, flow deflectors, and riblets, each offering unique approaches to attenuate noise. Vortex generators are small devices strategically placed in the flow path, promoting the creation of controlled vortices. These vortices can alter the flow's characteristics and aid in the mixing of fluid layers, thereby dissipating energy from turbulent structures and reducing noise. Flow deflectors, on the other hand, are used to redirect and manipulate the flow around sensitive areas, preventing the interaction of turbulent regions and reducing turbulence-induced noise.

Riblets, another passive flow control method, involve the introduction of small, streamwise grooves or rib-like structures on surfaces exposed to flow. These riblets have shown to modify the turbulent boundary layer, resulting in reduced skin-friction drag and attenuated noise generation. While these studies have provided valuable insights, there are still significant gaps and limitations that need to be addressed to achieve more effective noise reduction.

In recent times, researchers have been exploring passive control techniques inspired by natural surfaces found in organisms like the lotus leaf and shark skin. These surfaces exhibit unique features that suggest the possibility of achieving drag reduction through textured coatings. For instance, synthetic microscale structures resembling those on the lotus leaf have proven effective in reducing viscous drag by creating a slip velocity, allowing trapped air between the surface and water flow. This slip effect helps to lessen the resistance experienced by the flow. However, one limitation of these surfaces is that over time, they tend to lose their functionality as they become wet. Another fascinating example is the presence of denticles on shark skin, which also demonstrate drag-reducing properties.

Although not fully understood, these structures seem to hinder the formation and evolution of near-wall coherent motions. These near-wall motions are associated with increased drag, and by inhibiting them, the shark skin helps reduce resistance during movement. Despite the promising effects observed, the exact physical mechanism responsible for this drag reduction phenomenon is still a subject of ongoing debate.

Shark skin is renowned for its hydrodynamic efficiency, attributed to the presence of thousands of tiny, tooth-like scales known as denticles. These denticles possess unique periodic patterns and surface structures that contribute to reducing drag and turbulence, resulting in enhanced aerodynamic and hydrodynamic performance. Several previous studies have demonstrated the effectiveness of shark skin denticles as a metamaterial for flow control and aerodynamics. For example, researchers have investigated the application of shark skin-inspired textures on aircraft wings to reduce drag and enhance fuel efficiency. The presence of denticles on the wing surface disrupts the boundary layer flow, reducing turbulence and improving the overall aerodynamic performance. Furthermore, wind turbine blades have also been a focus of investigation regarding the application of shark skin denticles for noise reduction. By incorporating denticles on the blade surface, studies have shown a decrease in aerodynamic noise levels, resulting in a quieter operation and reduced environmental impact. In the field of submarine operations, the implementation of shark skin denticles on the hull surface has exhibited significant potential for noise reduction.

These denticles disrupt the flow patterns around the hull, minimizing hydrodynamic turbulence and consequently reducing the noise emitted by the submarine. Such noise reduction enhances stealth capabilities and minimize the impact on marine ecosystems. Herein, the effectiveness of a specially designed microsurface in alleviating flow separation and utilizing these shark skin denticles as a passive flow control technique for noise reduction in turbulent flows is demonstrated. The instant engineered microsurface comprises pillars that play a role in preventing the separation of fluid flow from surfaces. The simplicity of the manufacturing process and cost-effective fabrication of these pillars hold significant potential for influencing various energy applications. To achieve this goal, comprehensive experiments were conducted focusing on different applications such as UAM vehicles, wind turbines, and submarines. The subsequent sections hereinbelow provide detailed descriptions of the materials and methods employed in the experimental setup. Following that, the results obtained are presented and thoroughly discussed, highlighting the effectiveness and limitations of shark skin denticles in reducing turbulence induced noise. Finally, a comprehensive conclusion summarizes the findings, emphasizing their significance in practical applications and indications of future research directions.

Quasicrystal metamaterials are a fascinating class of artificial materials that combine the unique properties of quasicrystals and metamaterials. Quasicrystals are a type of crystal microstructure that possesses long-range order but lack translational symmetry, unlike traditional crystals. These quasicrystals were first discovered in the 1980s. Metamaterials, on the other hand, are engineered materials designed to exhibit extraordinary properties not found in nature. These properties often arise from their intricate microstructures and carefully tailored interactions with electromagnetic waves or acoustic waves. The concept of quasicrystal metamaterials involves incorporating the aperiodic and unique structural properties of quasicrystals into the design and fabrication of metamaterials. By combining these two distinct characteristics, we can create materials with unprecedented functionalities and performance.

One of the interesting features of quasicrystal metamaterials is their ability to control the propagation of waves, such as electromagnetic waves or sound waves, in ways that are not achievable with traditional materials. Their aperiodic structure allows them to possess a range of frequency bands that can control the transmission, reflection, and refraction of waves in specific directions. In the realm of optics, quasicrystal metamaterials have shown promise in manipulating light at the nanoscale. They can be designed to possess negative refractive indices, leading to phenomena like negative refraction and subwavelength focusing, which have significant implications for lensing and imaging applications. In the field of acoustics, quasicrystal metamaterials have been explored for their ability to control sound propagation. By tailoring the arrangement of the aperiodic structures, these materials can exhibit band gaps that prevent specific frequencies from propagating through them, leading to noise reduction and acoustic isolation properties. Moreover, quasicrystal metamaterials have been studied for their mechanical properties, showing potential for lightweight yet strong and resilient structures. Their unique aperiodic arrangement allows for excellent mechanical stability and exceptional vibration damping characteristics.

Noise pollution has become a pressing global concern with far-reaching implications across various industries and daily life. As a result, researchers worldwide have been diligently exploring innovative techniques to combat this pervasive problem. In recent years, the application of Fibonacci sequences on surfaces has emerged as a promising and attention-worthy advancement in the field of noise reduction. Quasicrystal metamaterials hold great potential in addressing noise pollution challenges. Their unique structural properties, derived from the combination of quasicrystals and metamaterials, enable precise control over the propagation of waves, including sound waves. By tailoring the arrangement of their aperiodic structures, these materials can exhibit band gaps that effectively block specific frequencies of noise, leading to noise reduction and acoustic isolation properties. As a result, quasicrystal metamaterials offer a promising avenue for developing innovative noise-cancelling technologies in various settings, from urban environments to transportation systems, contributing to a quieter and more harmonious living space for individuals and communities.

The rapid growth of Urban Air Mobility (UAM) has brought the promise of efficient and swift aerial transportation within urban areas. Helicopters and drones have become key players in this emerging field, offering the potential to revolutionize daily commuting and logistics. However, alongside the exciting prospects of UAM, there comes a significant concern regarding aviation noise. The noise generated by rotorcraft during flight, caused by blade vortex interaction and fluid displacement, poses a major challenge to the integration and acceptance of UAM in densely populated areas.

To address this issue, researchers have delved into innovative approaches, and one such promising avenue lies in the realm of meta crystals (MCs), specifically phononic crystals (PNCs). MCs are composite materials that combine two or more materials with distinct dielectric and/or elastic properties, and PNCs in particular focus on controlling elastic wave propagation. This capability holds immense potential for noise reduction and sound attenuation in a variety of engineering applications. Phononic crystals were introduced in the 1990s as periodic artificial acoustic functional materials, designed to manipulate elastic waves. By creating unique band gaps, these crystals effectively impede the transmission of elastic waves within specific frequency ranges, presenting an opportunity for noise reduction.

The concept of phononic crystals finds applications in noise insulation for submarines, sonar systems, and air flow control, offering valuable solutions for noise-related challenges. One-dimensional phononic crystal strips have shown impressive performance in noise reduction, exhibiting ultra-wide band gaps with remarkable sound attenuation properties. By constructing periodic pillars on the surface of a beam, these strips achieve band gaps through a combination of Bragg scattering and local resonances. Within just a few periods of the phononic crystal strip, sound transmission can be attenuated by over 150 dB, making them promising candidates for noise reduction in UAM vehicles. Additionally, we have explored aperiodic structures, such as Fibonacci superlattices, as a means of creating significant band gaps for acoustic wave propagation. By introducing alternating portions of materials with different elastic properties, these structures exhibit pronounced band gaps, further expanding the potential of phononic crystals in noise reduction.

The Fibonacci sequence, an elegant mathematical progression, has captivated scholars and nature enthusiasts for its recurring presence in various natural phenomena. Beginning with 0 and 1, each subsequent number is the sum of the two preceding ones, forming the renowned sequence: 0, 1, 1, 2, 3, 5, 8, 13, 21, 34, 55, 89, 144, and so forth. This fascinating numerical pattern manifests in numerous aspects of nature, from the spiral arrangement of leaves on a stem to the mesmerizing spirals found in seashells. Beyond its natural allure, the Fibonacci sequence's unique mathematical properties render it a valuable tool with diverse applications.

Herein, we delve into a particular application of the Fibonacci sequence two-dimensional square tiling Energy spectra and eigenstates of quasiperiodic tight-binding, the square Fibonacci tiling. This tiling is achieved through a two-letter substitution rule, where ‘S’ is substituted with ‘L,’ and ‘L’ is substituted with ‘LS,’ leading to the generation of an aperiodic sequence: LLSLSL The frequency ratio of the two letters ‘L’ and ‘S’ in this sequence converges to the golden ratio (1+5)/2. The essence of this two-dimensional square tiling lies in its aperiodic nature, giving rise to intriguing patterns and structures. When iteratively applied, the tiling creates complex arrangements that exhibit the essence of the Fibonacci sequence while preserving the characteristics of the golden ratio. This unique geometric progression not only captivates mathematicians but also intrigues artists, architects, and designers. Furthermore, the connection between the Fibonacci sequence and the golden ratio deepens our understanding of fundamental mathematical concepts. The golden ratio's significance extends far beyond geometry, making appearances in various fields such as art, architecture, and even music. This pervasive presence demonstrates the universal appeal and inherent harmony found in the Fibonacci sequence and its related mathematical properties. This mathematical construct finds application in various scientific disciplines, such as crystallography, where quasicrystals exhibit non-repeating patterns akin to aperiodic tiling. By exploring the connection between aperiodic tiling and the Fibonacci sequence, researchers gain valuable insights into the fascinating realm of mathematical structures and their real-world implications.

Herein, we focus on graphically representing the two letters ‘L’ and ‘S’ from the Fibonacci sequence using distinct long and short spacings on the grid axes, symbolized as ‘l’ and ‘s,’ respectively. These two dimensions are not only related to the Fibonacci sequence but are also connected by the golden ratio, a fundamental mathematical constant with unique properties.

To achieve the graphical representation, we consider a two-dimensional grid with ‘l’ and ‘s’ as the axes. The first generation of the Fibonacci sequence, which comprises the letters ‘L’, ‘L,’ and ‘S’ (LLS), can be visually depicted on this grid (FIG. A). To ensure that our graphical representation adheres to the golden ratio, we assign specific lengths to ‘l’ and ‘s’ based on their relationship to this constant. The golden ratio emerges naturally from the ratio of consecutive Fibonacci numbers as the sequence progresses. This leads to the determination of the following lengths for ‘l’ and ‘s’:‘l’=1.61803398875 units (approximately), ‘s’=1 unit.

With these lengths established, we proceed to create the graphical representation of the first generation (LLS) of the Fibonacci sequence in the following manner. We begin by placing a point at the origin (0, 0) on the grid. Next, we move along the ‘l’ axis to the right by a distance of 1.61803398875 units, which takes us to point A. From point A, we continue our movement along the ‘l’ axis to the right, covering the same length of 1.61803398875 units, ultimately arriving at point B. Subsequently, we shift our position along the ‘s’ axis downwards by 1 unit from point B, leading us to point C. The sequence of points A, B, and C on the grid forms the graphical representation of the first generation (LLS) of the Fibonacci sequence.

We continue our exploration of the graphical representation of the Fibonacci sequence. The focus now shifts to the next generation, which comprises the letters ‘L,’ ‘L,’ ‘S,’ ‘L,’ ‘L,’ ‘S,’ and ‘L’ (LLSLLSL) (see FIG. B). To graphically depict this sequence, we use the same two-dimensional grid with ‘l’ and ‘s’ as the axes, where ‘l’ represents a length of approximately 1.61803398875 units and ‘s’ is equivalent to 1 unit. Beginning with the initial representation of LLS (from the first generation), we mark three points on the grid: A, B, and C. Moving forward, we extend the sequence to LLSLL. From point C, the last point of the first generation, we move along the ‘l’ axis to the right by 1.61803398875 units, leading us to point D. Continuing the extension, we progress along the ‘l’ axis again by the same length of 1.61803398875 units to reach point E. Next, we shift along the ‘s’ axis downwards from point E by 1 unit, arriving at point F. Finally, to complete the representation of LLSLLSL, we add another ‘L’ to the sequence. From point F, we move along the ‘l’ axis to the right by 1.61803398875 units to reach point G. The sequence of points D, E, F, and G forms the graphical representation of the second generation (LLSLLSL) of the Fibonacci sequence.

By visually extending the sequence in this manner, we observe the recursive nature of the Fibonacci sequence and its ability to generate visually captivating patterns on the grid. Each subsequent generation builds upon the previous one, incorporating the golden ratio into the lengths of ‘l’ and ‘s,’ resulting in a symphony of geometric shapes that reflect the inherent beauty and harmony of the Fibonacci sequence.

In addition to the two-dimensional square tiling based on the Fibonacci sequence, we can also explore the generation of a slant structure using the same concept (see FIG. C). In this slant structure, we create a sequence by skipping every other letter from the Fibonacci sequence and use it to determine the placement of nodes on the grid. Similar to the previous representation, we consider the grid with ‘l’ and ‘s’ as the axes, and the lengths of ‘l’ and ‘s’ are still related to the golden ratio. By leveraging this modified sequence, we can construct a slant pattern that showcases the fascinating interplay between the Fibonacci sequence and the golden ratio. To begin the construction of the slant structure, we initiate with the original Fibonacci sequence: 0, 1, 1, 2, 3, 5, 8, 13, 21, 34, 55, 89, 144, and so on. Then, we generate a new sequence by skipping every other letter, resulting in: 0, 1, 2, 5, 13, 34, 89, and so forth. Next, we use this new sequence to determine the placement of nodes on the grid. Starting from the origin (0, 0) of the grid, we move along the ‘l’ axis by 1 unit to 56 reach the first node. From there, we move along the ‘l’ axis again, this time by 2 units, to reach the second node. Continuing this pattern, we move along the ‘l’ axis by 5 units, 13 units, and so on, to place subsequent nodes. As we progress along this slant structure, the distance between each node corresponds to the numbers in the modified Fibonacci sequence, highlighting the connection between the sequence and the spatial arrangement on the grid. This can be further extended to something like the 2D lattice as observed in FIG. D.

The concept of using mathematical principles, such as fractals, patterns, and aperiodic structures, to design acoustic surfaces for noise reduction is an area of ongoing research and development. Fibonacci acoustic design can be a cutting-edge technique to reduce noise, leveraging the mathematical beauty of the Fibonacci sequence and the golden ratio. By applying this process, a surface is adorned with a repeating pattern inspired by the Fibonacci sequence, where each rectangle's length-to-width ratio aligns with the golden ratio (approximately 1.618). These rectangles are then arranged following the sequence of the Fibonacci numbers, resulting in an aesthetically pleasing and functionally effective pattern. The Fibonacci sequence and the golden ratio in music. The effectiveness of such a design lies in sound wave diffusion due to the repeating pattern, reducing noise intensity.

The presence of the golden ratio can amplify this effect. It can find applications in concert halls, studios, and products like headphones. However, its efficacy can have limitations in terms of surface size, sound frequency, and practical constraints.

This article delves into the concept of Fibonacci sequences and their ingenious use on surfaces to mitigate noise, presenting a simple yet highly effective approach that holds the potential to revolutionize noise reduction strategies (like a quasi-crystal metamaterial). By drawing inspiration from nature's patterns and the mathematical elegance of Fibonacci sequences, this novel method offers hope in creating quieter, more serene environments for individuals and communities alike.

### Overview of Methodology and Materials

Herein, we will explore three primary subsections focusing on the fabrication and design of micro-pillars inspired by shark skin, the experimental approach used in this study, and the techniques employed for data collection and measurements.

### Engineered Metamaterial

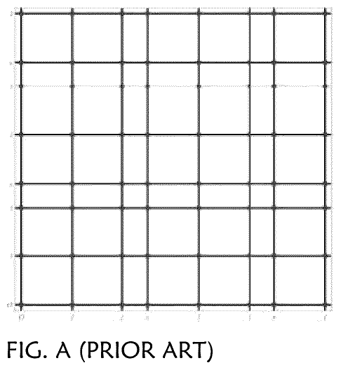

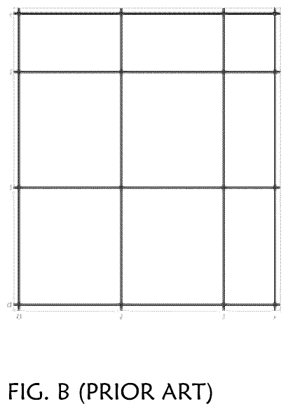

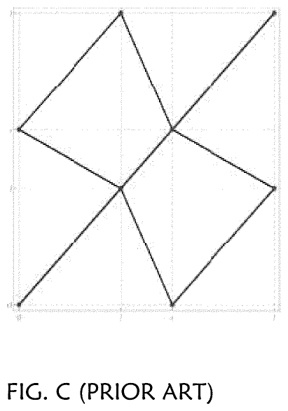

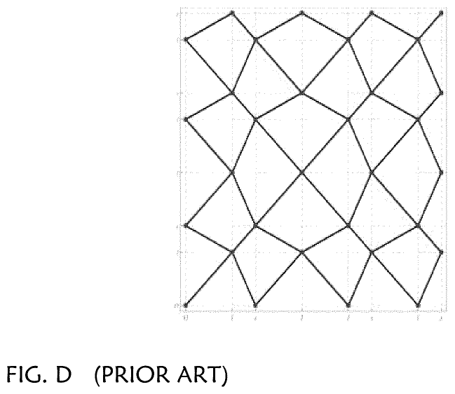

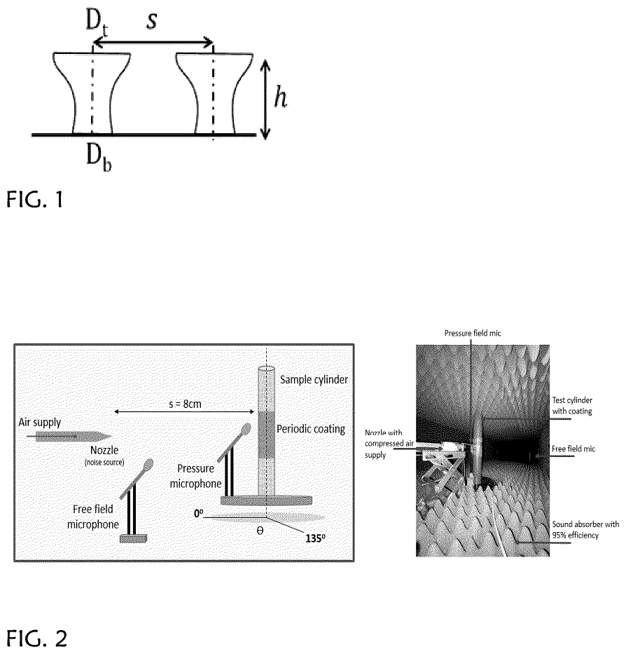

The engineered bio-inspired surface draws its inspiration from the shark-skin denticles. Three types of micro-scale coatings were used, with varying spacing-to-height ratio as well as stalk and tip diameters as shown in FIG. 1 and Table 1 Herein, the pillars utilized are different from actual shark skin denticles in several ways. Firstly, while shark skin denticles are asymmetric, the instant pillars are axisymmetric. They lack the channel-like indentations present on the top surfaces of natural denticles. Another difference lies in the arrangement of the pillars, wherein the instant pillars are arranged in a Cartesian layout with a periodic arrangement, featuring a distinctive “spatula” shape. The pillars are organized in a square packing with aligned rows and columns. In contrast, natural shark denticles overlap and are randomly aligned, presenting a distinct pattern in their formation. Herein, h=height of the diverging micropillars; Dt=diameter of mushroom shaped top; Db=diameter of stalk. Coatings s h Dt Db; C1 45 μm 15 μm 28 μm 26 μm; C2 235 μm 70 μm 158 μm 108 μm; C3 195 μm 145 μm 150 μm 82 μm.

TABLE 1
Coating Type

| | | | | |
|---|---|---|---|---|
| Coatings | s | h | Dₜ | D_{b} |

| | | | | | | | | |
|---|---|---|---|---|---|---|---|---|
| C1 | 45 | μm | 15 | μm | 28 | μm | 26 | μm |
| C2 | 235 | μm | 70 | μm | 158 | μm | 108 | μm |
| C3 | 195 | μm | 145 | μm | 150 | μm | 82 | μm |

S: center-to-center spacing, h: height of the diverging micropillars; Dt: diameter of mushroom shaped top; Db: diameter of stalk)

The exemplary configuration, as illustrated in FIG. 2, comprises several key components. These include a circular converging nozzle equipped with a gauge pressure regulator to control the supply of compressed air, a sample cylinder (2″ PVC pipe) as a bluff body, and ¼″ pressure field and free field microphones (TYPE 4938-A-011 and TYPE 4939-A-011, respectively), both connected to a LAN-XI module (TYPE 3052) for signal input and processing. The pressure field microphone could be moved to varying angular positions around the cylinder while the free field microphone was fixed at a distance from the flow and the cylinder.

To carry out the experiments, a specially designed chamber was constructed within a wind tunnel. This wind tunnel served as a black-box setup (200cm*90cm*45 cm) and was enveloped with a contoured sound-absorbing sheet made of humidity-resistant polyurethane foam, which boasted an impressive 95% noise absorption efficiency. The combination of these elements ensured controlled and reliable conditions for conducting the investigations.

TABLE 2.2
Experimental design matrix

| | |
|---|---|
| Test samples | C0, C1, C2, C3 |
| Exit nozzle Mach number (calculated) | 0.4 (M1), 0.6 (M2), |
| | 0.95 (M3) |
| θ (angular positions of pressure microphone) | 5°, 15°, 30°, 45°, 60°, 75°, |
| | 90°, 105°, 120°, 135° |
| Dₑₓᵢₜ (outer nozzle diameter) | 1.27 cm (0.5 in.) |
| Dᵢₙ (inner nozzle diameter) | 2.54 cm (1 in.) |
| s (distance between nozzle exit and cylinder | 6.3Dₑₓᵢₜ |
| surface) | |
| Distance between pressure mic to cylinder | 0.24Dexit |
| surface | |
| Distance between free field mic to cylinder | 88Dexit |
| surface | |

In this setup, the nozzle jet served as the sound source. The pressure gauge was set to three gauge pressure levels that corresponded to varying nozzle exit Mach number range in subsonic and transonic flow regime calculated using isentropic variable area nozzle flows. The calculated Mach numbers and corresponding gauge pressure setting is shown in Table 3. The microphone calibration and reading is indicative enough to support the current data and results. This research shows that for the aimed Mach numbers within our study, we reach similar magnitude of sound pressure level as they did. Additionally, in a standard city traffic environment, noise levels can vary widely for different sources at specific distances. A single car traveling at 30 mph, located 50 feet away, generates approximately 62 dBA, while city traffic at 30-50 feet away produces around 85 dBA. A subway train, situated 200 feet away, generates a higher noise level of approximately 95 dBA. A helicopter flying 1,000 feet away generates a moderate noise level of approximately 78 dBA, while a jet aircraft taking off from 100 feet away creates a substantially loud noise level of approximately 140 dBA. These noise measurements underscore the importance of managing and reducing noise pollution in urban areas to safeguard public health and improve the overall living environment for city residents. In our case across M1, M2 and M3, we observe a noise level variation between 65 dB to 110 dB for pressure microphone and for free field microphone it was around 60 dB to 68 dB. The testing involved using a cylindrical body, which represented a curved body for the experiments. This simple cylindrical shape was chosen as a representative model among the complex geometries typically found in an Urban Air Mobility (UAM) vehicle. The cylindrical body was coated with three distinct micro-pillar coatings. The design matrix, presented in Table 2, provides essential information related to the experimental setup. It includes details such as the nozzle diameter, positions of microphones, and other relevant parameters necessary for the investigation.

TABLE 3
Gauge pressure of compressed air and
calculated exit nozzle Mach number

| Gauge pressure | Mach number (calculated) |
|---|---|
| 2 psi | 0.4 |
| 4 psi | 0.6 |
| 11 psi | 0.95 |

We also used flat-plate test samples coated with the three types of micro-pillars in the same set up for further investigation of the jet flow and bluff body interaction and noise suppression dynamics.

### Pressure Measurement

Two microphones were employed to assess pressure fluctuations resulting from the interaction between the jet flow and the bluff body (cylinder). A pressure field microphone was positioned in close proximity to the cylinder surface, allowing for precise measurements of the pressure changes in that region. On the other hand, a free field microphone was situated at a distance from the flow, covered with a wind screen to minimize unwanted disturbances. Data collection was conducted at a high sampling rate of 262144 Hz, capturing a substantial amount of information during the 50-second experimental period. However, to ensure the analysis focused on the steady-state conditions, the signal data utilized for further investigation spanned from the 25th second to the 50th second. This 25-second interval encompassed the time when the signal had stabilized after approximately 20 seconds, providing a reliable and representative dataset for analysis. The effective sampling frequency for the analyzed data was 131072 Hz.

In our research, we proceeded to generate the coordinates for both the straight and slant arrangements based on the Fibonacci sequence and the modified sequence, respectively. By applying the principles of the Fibonacci sequence to the grid with ‘l’ and ‘s’ as the axes, we determined the positions of nodes for both the straight and slant structures. Having established these coordinates, we then embarked on the implementation of nanometric cylindrical structures at these identified nodes. This innovative approach aimed to harness the potential of these structures in achieving noise reduction. The placement of these nanometric cylindrical structures on the nodes was strategically designed to exploit the unique geometric patterns generated by the Fibonacci sequence and its modified counterpart. By leveraging the relationship between the Fibonacci sequence and the golden ratio, we optimized the arrangement of these structures for effective noise reduction. The implementation of nanometric cylindrical structures on the grid nodes in both the straight and slant arrangements provided a novel approach to tackle the problem of noise pollution. These structures exhibited promising noise reduction properties due to their ability to diffuse and scatter sound waves effectively, disrupting their propagation and intensity.

We have generated unique codes for constructing the 2D and 3D Fibonacci quasicrystal microstructure coatings. These were tested on the same cylindrical bodies (as for the experiments with periodic structures) for noise reduction. This is the major innovation, where such resilient and easy to install micro-structures can be used for significant noise reduction and enable urban air facilities. The Fibonacci quasicrystal microstructure has not been tested for fluid flow control based experiments before specifically for applications in the air industry. We strove to find an optimized shape and size for the micro-structure arrangement taking inspiration from nature (golden ratio) as well as experience in testing the periodic structures. This can be applied to different complex curvatures like cylinder, airfoils, wings, and the like. We have demonstrated applicability over different flow regimes like subsonic and supersonic, so that these coatings can find a wide range of applications for noise attenuation in the aerospace industry. Another advantage of using these microstructures is that due to the change in pressure field around these structures, aerodynamic efficiency can also be enhanced by careful placement and arrangement of the same on the airfoil/ wing. The integration of advanced manufacturing techniques, computational fluid dynamics, and optimization methods enables the commercial viability of metamaterial coatings for UAM. This includes considerations of large-scale fabrication, cost-effectiveness, and ease of application.

### EXAMPLE

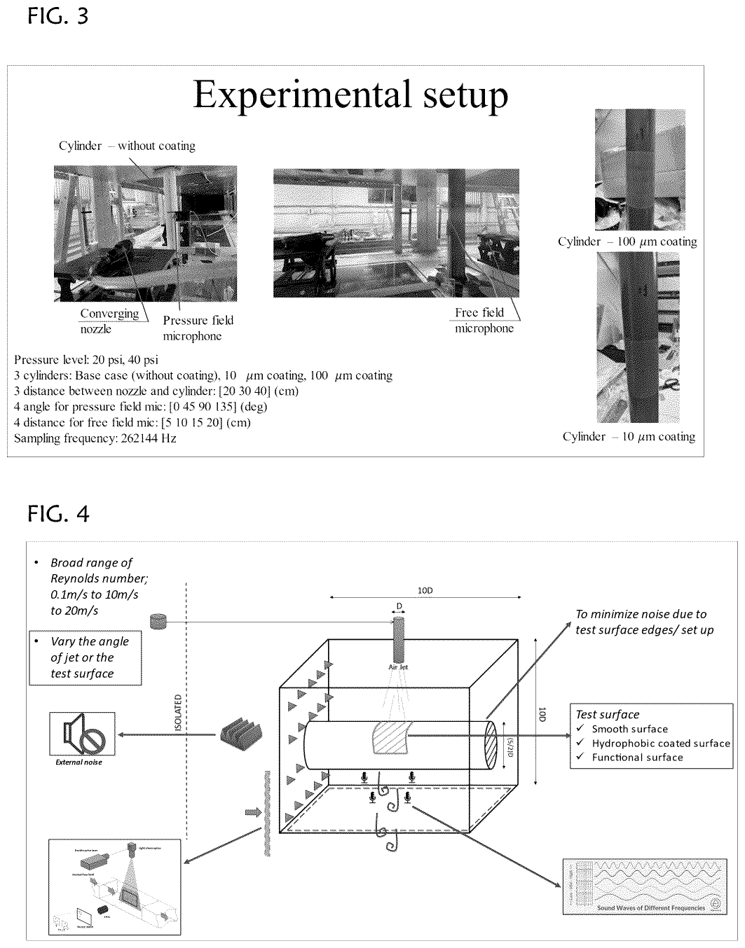

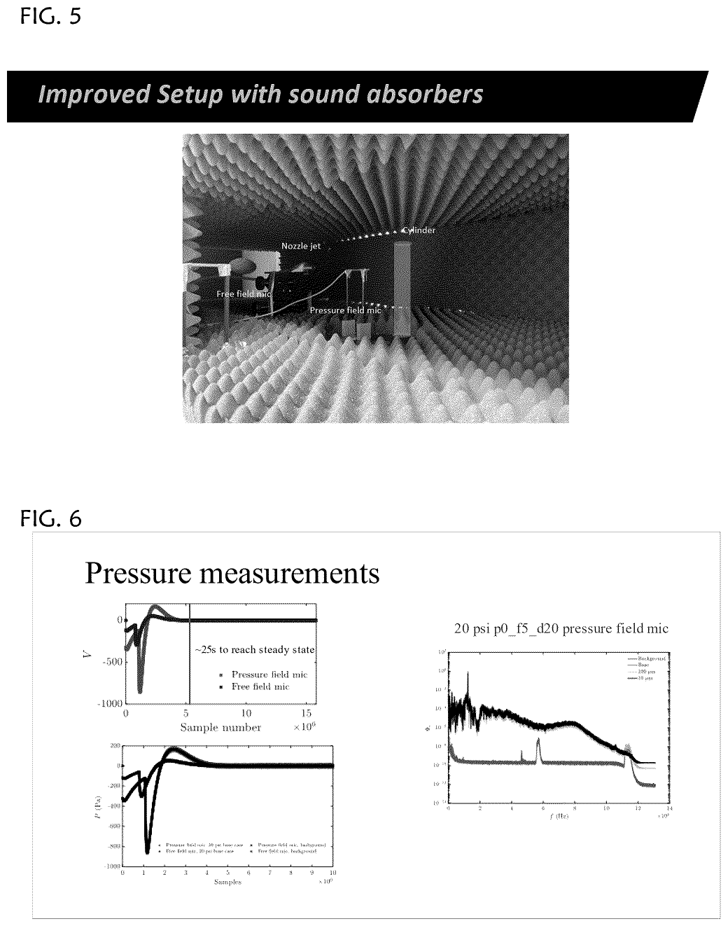

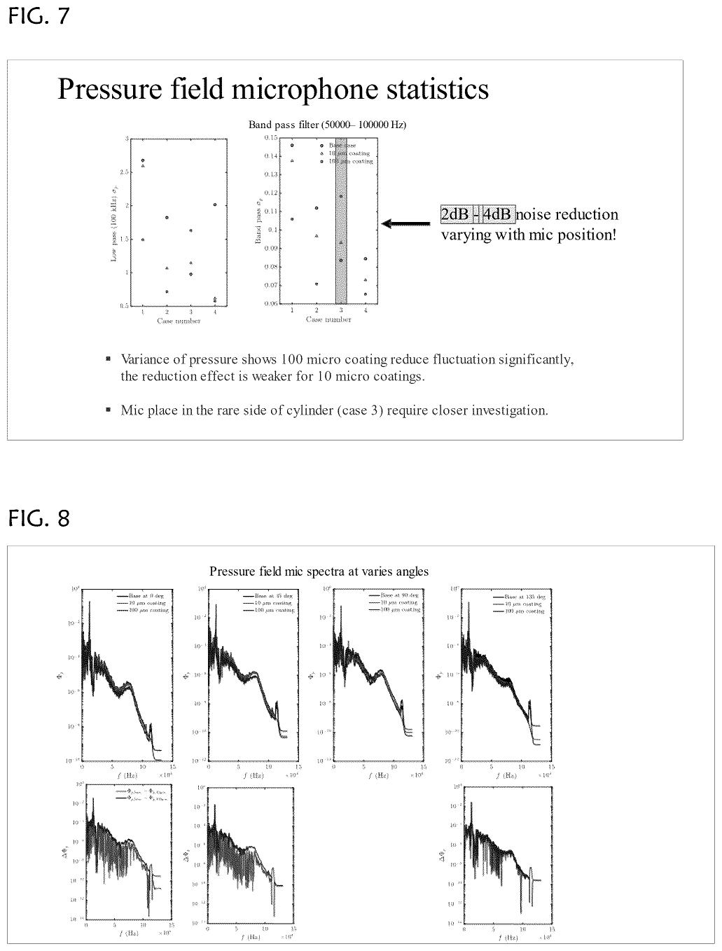

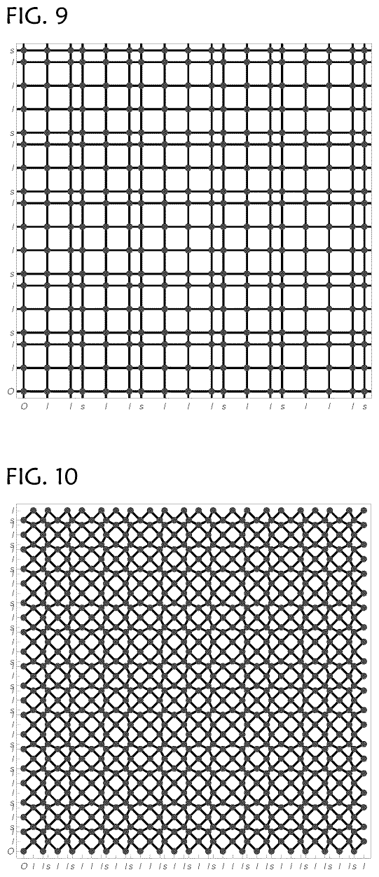

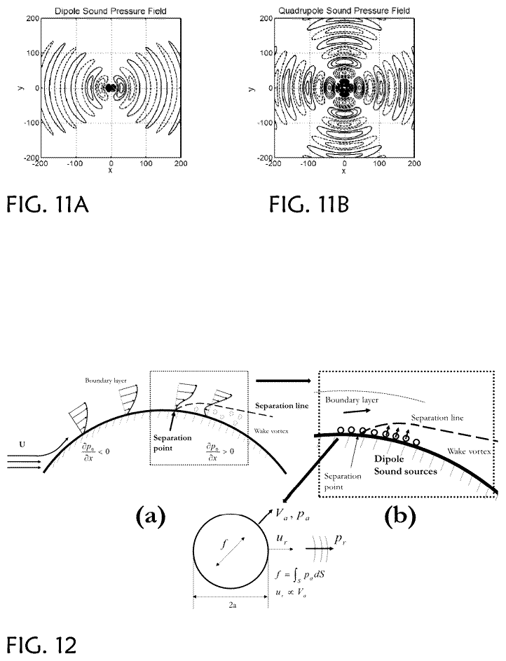

FIGS. 1-12 refer to a first embodiment of the present novel technology, a sound absorbing coating for aircraft propeller and turbine blades. Metamaterials, in particular meta-crystals (MCs) such as photonic time crystals (PTCs) and phononic crystals (PNCs) and the like are heterostructures/composites consisting of at least two materials differing in their dielectric and/or elastic properties, respectively. The Maxwell equations describe the state of photons in a PTC while the elastic wave equations characterize the behavior of other waves in PNC. The phononic crystals are excellent for controlling elastic waves from the geometric structure. In fact, the phononic crystal is a type of periodic artificial acoustic functional material that inhibits or prevents the propagation of elastic waves within a certain frequency range, such as within the band gap. These phononic crystals exhibit an excellent potential for practical engineering of noise reduction. PNCs have potential applications in submarine silencing, sonar, and air flow noise insulation. In fact, it has been theoretically demonstrated that a one-dimensional phononic crystal strip shows an ultra-wide band gap is present. This strip theoretically consists of periodic pillars constructed on the surface of a beam. These pillars can be constructed by either applying a coating with the desired shapes, by mechanically texturizing the surface, or a combination of the two techniques. This modification of the surface of the beam enables the generation of a band gap, due to both Bragg scattering and local resonances. The optimized combination of these two effects results in the lowering and widening of the main band gap, leading to a gap-to-mid-gap ratio of about 138%. This theoretically leads, according to the literature, to a strong attenuation of sound/noise transmission, perhaps in excess of 150 dB for only five periods. Additionally, the appearance of significant bad gaps in acoustic waves propagating in a Fibonacci or aperiodic superlattice, consisting of alternating portions of materials with different elastic properties, has been demonstrated.

Herein, we include examples wherein using nozzle jet flow at Mach <1 and Mach >1 were performed on cylindrical bodies. The cylinders are coated with periodically arranged micro-structures at the center region. These are classified as low strength fibers (tip diameter 28 um, stalk diameter 26 um, height 15 um, center-to-center spacing 45 um) and high strength fibers (tip diameter 150 um, stalk diameter 82 um, height 145 um, 195 um center-to-center spacing, hex packing). These were compared against a base cylinder with a smooth surface. A pressure-field microphone and far-field microphone (at varying positions around the cylinder) were used for collecting noise spectrum data. The preliminary results for periodic micro-coating show 2-4 dB of overall noise reduction in the case of high strength fibers, as compared to the base cylinders, for low-pass filtering. The surface modification enabled the generation of a band gap leading to a strong attenuation of sound/noise transmission. Our previous studies have shown us that the microfibers have displayed remarkable properties to suppress propeller noise and delay flow separation, and thus pressure drag, by transferring energy and momentum from the outer flow to the viscous inner regions of the boundary layer.

After testing the periodic micro-structure coating, the next step is to test for aperiodic Fibonacci quasicrystal tiling in application for noise cancellation for urban air mobility. A simple example of such an arrangement is shown in the drawings.

Codes for constructing the 2D and 3D Fibonacci quasicrystal microstructure coatings have been generated. So constructed micro-coatings were tested on the cylindrical bodies to assess their potential for noise reduction. Such resilient and easy to install micro-structures are used for significant noise reduction and enable urban air facilities. The so-generated Fibonacci quasicrystal microstructure has been tested for fluid flow control-based experiments specifically for applications in the aircraft industry. The parametric study was to find an optimized shape and size of the micro-structure arrangement taking inspiration from nature (golden ratio) as well as using our experience in testing the periodic structures. This was applied to different complex curvatures like cylinder, airfoils, wings, and the like. We define our study over different flow regimes like subsonic and supersonic, so that these coatings can find a wide range of applications for noise attenuation in the aerospace industry. Another advantage of using these micro-structures is that due to the change in pressure field around these structures, aerodynamic efficiency can also be enhanced by careful placement and arrangement on the airfoil/wing.

Design optimization of the microscale texturing in selected locations of a UAM vehicle is a challenging process due to the distinct physics involved in the noise absorption and decomposition within the micro patterns. We have conducted a variety of canonical and geometry-specific flow diagnostics measurements with state-of-the-art methods to inform the optimization process. Reduced level of broadband noise from various sources in UAM vehicles has multiple environmental and economic advantages and would trigger massification of the technology in urban settings.

### Conclusions

The coated cylinder case (C1, C2, C3) have higher reduction in pressure fluctuations than non-coated base case (C0).
C1 and C3 have similar behavior.
There is a peak energy at 800 Hz frequency across all Mach numbers, indicating vortex shedding. Vortex shedding is a phenomenon that occurs when a fluid (such as air or water) flows past a solid object, creating alternating swirling patterns of fluid motion in the wake of the object. In case of the coatings, it can be observed that at around 800Hz, there is a peak developing as the microphone moves closer to the wake of the cylinder. This means that there is development of vortex shedding causing that peak; however it can be seen that the presence of the coating suppresses the intensity of vortex shedding, hence an observed reduction in pressure fluctuations and noise. The nature of the coated and non-coated case show a similar trend with change in intensity of the pressure fluctuations, indicative of the suppression of turbulent intensity. At lower frequencies, there is higher noise reduction and thus a greater suppression of large turbulent eddies.
For a Reynolds number in range 10⁴ to 10⁶, the observed Strouhal number (f*d/u) is close to 1.8 to 2. For this range, the velocity observed is between 190 m/s to 250 m/s at 800 Hz. This is in coherence with the impinging jet order of magnitude of velocity from calculated Mach numbers.
If solid boundaries are present, (i) the sound generated by the quadrupoles of Lighthill's theory will be reflected and diffracted by the solid boundaries. (ii) the quadrupoles will no longer be distributed over the whole of space, but only throughout the region external to the solid boundaries, and there might be a resultant distribution of dipoles (or even sources) at the boundaries, according to Lighthill

$$ρ - {ρ}_{0} = \frac{1}{4 π {a}_{0}^{2}} \frac{{\partial }^{2}}{\partial {x}_{i} \partial {x}_{j}} {\int }_{v} {T}_{i , j} \frac{( y , t - \frac{\vert x - y \vert}{{a}_{0}} )}{\vert x - y \vert} dy$$

$$ρ - {ρ}_{0} = \frac{1}{4 π {a}_{0}^{2}} \frac{{\partial }^{2}}{\partial {x}_{i} \partial {x}_{j}} {\int }_{v} {T}_{i , j} \frac{( y , t - \frac{\vert x - y \vert}{{a}_{0}} )}{r} dy - \frac{1}{4 π {a}_{0}^{2}} \frac{{\partial }^{2}}{\partial {x}_{i}} {\int }_{S} \frac{{P}_{i} ( y , t - \frac{r}{{a}_{0}} )}{r} dS ( y )$$

With addition of micropillars on the curved surface, the net surface area of the solid boundary changes varying over C0, C1, C2 and C3. The net surface area is given by

Fᵢ=∫_{S}Pᵢ(y, t) dS(y)

where P₁ is force per unit area exerted on the fluid by the solid boundaries in xᵢ direction, and

2πrₒ+nₓ·n_{y}·2πrₘhₘ=(SA)_{Cm}

where, rₒ is the diameter of a sample cylinder, l is the length of coating applied (such as 8 inch) on the cylinder, nₓ·n_{y} is the total number of micropillars on the cylinder surface, rₘ is the average of top and bottom diameter of micropillar, hₘ is the height of the micropillar and m=0, 1, 2, 3. We find, (SA)_{C3}>(SA)_{C1}>(SA)_{C2}>(SA)_{C0} which implies (Pᵢ)_{C0}>(Pᵢ)_{C2}>(Pᵢ)_{C1}>(Pᵢ)_{C3} assuming Fᵢ is constant for a particular Mach number flow. This is supported by the experimental findings as we observe C1 and C3 have a similar behavior and the coated surface reduces pressure fluctuations as compared to the uncoated or smooth case.

Thus, while the disclosure has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A reduced noise curved surface, comprising:
a curved substrate;
a plurality of micropillars operationally connected to the curved substrate and defining a coating;
wherein the respective micropillars are positioned to define an aperiodic sequence based on the golden ratio;
wherein the plurality of aperiodically sequenced micropillars increase sound absorption and drag reduction of the curved surface.

2. The reduced noise curved surface of claim 1 wherein the curved substrate is selected from the group consisting of aircraft fuselage, fixed aircraft wing, aircraft rotor blade, and combinations thereof.

3. The reduced noise curved surface of claim 1 wherein the curved substrate is selected from the group consisting of submarine hull, submarine rudder, submarine rotor blade, and combinations thereof.

4. The reduced noise curved surface of claim 1 wherein the coating has a spatula shape.

5. The reduced noise curved surface of claim 1 wherein each respective micropillar is a curved elongated member shaped like a shark skin denticle.

6. A propeller blade, comprising:
a curved propeller blade surface;
a plurality of quasicrystal micro-structures operationally connected to the curved propeller blade surface;
wherein the respective quasicrystal micro-structures are distributed to define a Fibonacci sequence;
wherein the plurality of Fibonacci sequenced quasicrystal micro-structures increase sound absorption and drag reduction of the curved surface.

7. The propeller blade of claim 6 wherein the Fibonacci sequenced quasicrystal micro-structures define a 2D lattice.

8. The propeller blade of claim 6 wherein the Fibonacci sequenced quasicrystal micro-structures define a 3D lattice.

9. The propeller blade of claim 6 wherein the respective quasicrystal micro-structures are phononic crystals.

10. The propeller blade of claim 6 wherein the respective quasicrystal micro-structures are elongated members between X mm and Z mm in length.

11. The propeller blade of claim 6 wherein the Fibonacci sequenced quasicrystal micro-structures define a lattice with a surface area (SA) defined as 2πrₒ+nₓ·n_{y}·2πrₘhₘ=(SA)_{Cm}, wherein rₒ is the diameter of a sample cylinder, l is the length of coating applied on the cylinder, nₓ·n_{y} is the total number of micropillars on the cylinder surface, rₘ is the average of top and bottom diameter of micropillar, and hₘ is the height of the micropillar.

12.
